(19) United States
(12) Patent Application Publication
(10) Pub. No.: US 2014/0038653 A1
(43) Pub. Date: Feb. 6, 2014

(54) RADIO BASE STATIONS AND METHODS THEREIN FOR HANDLING INTERFERENCE AND SCHEDULING RADIO RESOURCES ACCORDINGLY

(71) Applicants: Gunnar Mildh, Sollentuna (SE); Gabor Fodor, Hasselby (SE); Jari Vikberg, Jarna (SE); Tomas Hedberg, Stockholm (SE)

(72) Inventors: Gunnar Mildh, Sollentuna (SE); Gabor Fodor, Hasselby (SE); Jari Vikberg, Jarna (SE); Tomas Hedberg, Stockholm (SE)

(73) Assignee: Telefonaktiebolaget L M Ericsson (publ), Stockholm (SE)

(21) Appl. No.: 14/112,426

(22) PCT Filed: Apr. 19, 2011
(86) PCT No.: PCT/SE11/50479

§ 371 Date: Oct. 17, 2013

(51) Int. Cl. H04W 16/14

(52) U.S. Cl. CPC H04W 16/14
USPC 455/501

(57) ABSTRACT

Embodiments herein relate to a first radio base station (12) for handling radio interference in a radio communications network, which first radio base station (12) provides radio coverage over a geographical area forming a first cell (14). In the first cell (14) a first user equipment (10) and a second user equipment (11) are served, which first radio base station (12), the first user equipment (10) and the second user equipment (11) are comprised in the radio communications network. The first radio base station (12) determines that a first radio resource is allocated to the first user equipment (10) for communicating over a device-to-device, D2D, connection with the second user equipment (11) within the first cell (14), The first radio base station then transfers information to an arrangement serving a second cell (15), which information identifies the first radio resource and indicates that the first radio resource is allocated to the first user equipment (10) for communicating over the D2D connection with the second user equipment (11) within the first cell (14). The information is to be taken into account by the arrangement serving the second cell (15) for scheduling a second radio resource to a third user equipment (16) in the second cell (15).

### TECHNICAL FIELD

Embodiments herein relate to a first radio base station, a second radio base station and methods therein. In particular, embodiments herein relate to handle radio interference in a radio communications network.

### BACKGROUND

In today's radio communications networks a number of different technologies are used, such as Long Term Evolution (LTE), LTE-Advanced, 3rd Generation Partnership Project (3GPP) Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few. A radio communications network comprises radio base stations providing radio coverage over at least one respective geographical area forming a cell. User equipments are served in the cells by the respective radio base station and are communicating with respective radio base station. The user equipments transmit data over an air or radio interface to the radio base stations in uplink (UL) transmissions and the radio base stations transmit data over an air or radio interface to the user equipments in downlink (DL) transmissions.

In orthogonal frequency division multiple access (OFDM) networks, user equipments are allocated orthogonal and thus non-interfering resources in the time and frequency domains. To achieve high resource utilization, modern multicell radio communications networks reuse all time and frequency resources in each cell, also referred to as ‘reuse 1’, and employ sophisticated Inter-Cell Interference Coordination (ICIC) techniques to reduce the interference caused by surrounding cells.

For example, the 3GPP standardized an inter-cell, inter radio base station, communication protocol over the so called X2 interface between radio base stations that allows neighbor radio base stations to communicate with one another. Such X2 based ICIC allows radio base stations to either proactively or reactively inform each other on the usage of time, frequency and power resources and to take into account such inter-cell information in their scheduling and OFDM Resource Block (RB) allocation.

The specific ICIC algorithms that radio base stations employ may depend on the vendor's or network operator's ICIC strategy and/or the current traffic load and/or network deployment and other circumstances and are out of the scope of communication standards.

Network Assisted (NA) Device-to-Device (D2D) communications has recently been proposed as a means of increasing the spectrum efficiency of cellular networks. In general, in a NA D2D scenario, the radio base station preserves most of the control plane functionalities of the communicating devices, which relate to the control of the communication, while user data is communicated directly over the radio interface between the D2D pair of user equipments. For example, the radio base station may decide which OFDM resource blocks that should be used during a particular Transmission Time Interval (TTI) for D2D communication.

Depending on the particular technical solution, some other control plane functionalities may be delegated to the participating devices. For example, the transmitting (TX) user equipment may set the transmit power for user data up to a maximum transmit power level determined by the radio base station. The user equipments in the D2D pair may also actively participate in determining the radio channel quality of the D2D connection by transmitting, measuring and reporting on a Sounding Reference Signal (SRS). A SRS is a pre-defined signal, pre-known to both TX user equipment and receiving (RX) user equipment. The received SRS is compared to the pre-known SRS and the radio channel quality is based on the comparison.

In NA D2D communications, there are several alternatives with regards to the allocation of radio resources for the D2D connection or link. Such radio resources may comprise OFDM resource blocks in the time and frequency domains and/or transmission power. To maximize spectrum efficiency, it is desirable to reuse OFDM resource blocks within the coverage area of a single cell for both cellular and D2D connections. In such a case, as opposed to the traditional cellular scenario, intra-cell interference is no longer negligible, since there may be simultaneous overlapping usage of OFDM resource blocks between cellular and D2D links. Cellular connection herein means a connection between the radio base station and a user equipment.

For a specific pair of communicating user equipments, the radio base station may also change between cellular mode, i.e. user equipments communicating through the radio base station, or D2D mode, i.e. user equipments communicating through a direct link. This change may depend on the user equipments geographical position, mobility or changes in the propagation characteristics, interference situation, traffic load variations or other factors. For example, a user equipment in a D2D pair may move around in the cell and, if the distance between the user equipments forming the D2D pair becomes too large, due to mobility, then the user equipment may cause too much interference. Instead the radio base station may then change the communication to a cellular connection via the radio base station.

A specific D2D pair uses either downlink or uplink radio resources during the transmission of some user data from the TX user equipment to the RX user equipment. When DL resources are used the TX user equipment may be in close proximity of a cellular user equipment of a neighbour cell receiving cellular DL data from a radio base station serving the neighbour cell. Without D2D communication, the cellular user equipment would suffer radio interference from the radio base station serving the TX user equipment. The distance between the radio base station serving the TX user equipment, and the user equipment in the neighbour cell is at least the cell radius. With D2D communications, the TX user equipment, which is then the interfering device, may be very close causing outage to the cellular user equipment in the neighbour cell, i.e. may totally interfere out the cellular user equipment.

When UL resources are used for D2D transmission, the problem is similar to the DL situation but the victim in this situation is the RX UE of the D2D pair. In this case the cellular user equipment in the neighbor cell transmits in the UL and may cause strong interference to the RX user equipment of the D2D pair, being close to the neighbor cell. This basic radio interference problem is similar although it appears at different time scales depending on the resource reservation scheme used.

### SUMMARY

An objective of embodiments herein is to provide a mechanism that mitigates radio interference in a cell of a radio communications network.

According to an aspect of embodiments herein the object is achieved by a method in a first radio base station for handling radio interference in a radio communications network. The first radio base station provides radio coverage over a geographical area forming a first cell. In the first cell a first user equipment and a second user equipment are served. The first radio base station, the first user equipment, and the second user equipment are comprised in the radio communications network. The first radio base station determines that a first radio resource is allocated to the first user equipment for communicating over a device-to-device, D2D, connection with the second user equipment within the first cell. The first radio base station transfers information to an arrangement serving a second cell. The information identifies the first radio resource and indicates that the first radio resource is allocated to the first user equipment for communicating over the D2D connection with the second user equipment within the first cell. The information is to be taken into account by the arrangement serving the second cell for scheduling a second radio resource to a third user equipment in the second cell. The arrangement may be comprised in the first radio base station or a second radio base station.

In order to perform the method a first radio base station is provided for handling radio interference in the radio communications network. The first radio base station is configured to provide radio coverage over a geographical area forming a first cell serving a first user equipment and a second user equipment. The first radio base station comprises a determining circuit configured to determine that a first radio resource is allocated to the first user equipment for communicating over a device-to-device, D2D, connection with the second user equipment within the first cell. The first radio base station further comprises a transferring circuit configured to transfer information to an arrangement serving a second cell. The information identifies the first radio resource and indicates that the first radio resource is allocated to the first user equipment for communicating over the D2D connection with the second user equipment within the first cell. The information is to be taken into account by the arrangement serving the second cell for scheduling a second radio resource to a third user equipment in the second cell.

According to an aspect of embodiments herein the object is achieved by a method in a second radio base station for scheduling a second radio resource to be used by a third user equipment in a radio communications network. The second radio base station provides radio coverage over a geographical area forming a second cell serving the third user equipment. The second radio base station and the third user equipment are comprised in the radio communications network. The second radio base station receives information from an arrangement serving a first cell. The information identifies a first radio resource and indicates that the first radio resource is allocated to a first user equipment for communicating over a D2D connection with a second user equipment within the first cell. The second radio base station further schedules a second radio resource to the third user equipment by taking the information into account.

In order to perform the method a second radio base station for scheduling a second radio resource to be used by a third user equipment in a radio communications network is provided. The second radio base station is configured to provide radio coverage over a geographical area forming a second cell serving the third user equipment. The second radio base station comprises a receiving circuit configured to receive information from an arrangement serving a first cell. The information identifies a first radio resource and indicates that the first radio resource is allocated to a first user equipment for communicating over a D2D connection with a second user equipment within the first cell. The second radio base station further comprises a scheduler configured to schedule a second radio resource to the third user equipment taking the information into account.

By informing the second radio base station about radio resource or resources used for D2D, the corresponding radio resource in the second cell may be scheduled or changed to be scheduled in a non-interfering manner, e.g. not a D2D connection close to the first cell. Thereby, the radio interference is mitigated in the radio communications network.

### BRIEF DESCRIPTION OF THE DRAWINGS

Embodiments will now be described in more detail in relation to the enclosed drawings, in which:

FIG. 1 is a schematic overview depicting a radio communications network,

FIGS. 2a-c are schematic overviews depicting communications in a radio communications network,

FIG. 3 is a combined flowchart and signalling scheme in a radio communications network,

FIG. 4 is a combined flowchart and signalling scheme in a radio communications network,

FIG. 5 is a flowchart of a method in a first radio base station,

FIG. 6 is a block diagram depicting a first radio base station in a radio communications network,

FIG. 7 is a flowchart of a method in a second radio base station, and

FIG. 8 is a block diagram depicting a second radio base station in a radio communications network.

### DETAILED DESCRIPTION

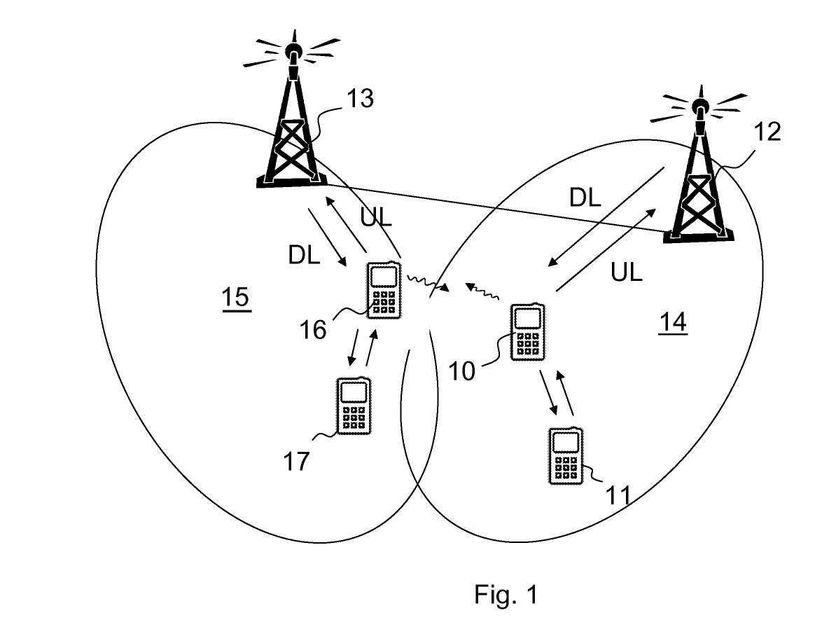

FIG. 1 is a schematic overview of a radio communications network. A number of different technologies may be used in the radio communications network LTE, LTE-Advanced, 3GPP WCDMA, GSM/EDGE, WiMax, or UMB, just to mention a few possible implementations.

The radio communications network comprises a first radio base station 12 and a second radio base station 13. Each radio base station provides radio coverage over at least one geographical area forming a first cell 14 and a second cell 15. A first user equipment 10 and a second user equipment 11 are served in the first cell 14 by the first radio base station 12. A third user equipment 16 and a fourth user equipment 17 are served in the second cell 15 by the second radio base station 13. When being in a cellular mode, the user equipments 10,11,16,17 may transmit data over a radio interface to the respective radio base station in uplink (UL) transmissions. The radio base stations 12,13 may transmit information to the user equipments 10,11,16,17 in downlink (DL) transmissions.

However, according to embodiments herein, the first user equipment 10 is directly communicating over a radio interface with the second user equipment 11, i.e. over a Device-to-Device (D2D) connection, in the first cell 14. Thus, the first user equipment 10 and the second user equipment 11 form a D2D pair. The first radio base station 12 has allocated one or more radio resources e.g. Resource Blocks (RB) over time and frequency and with a transmission power, to the first user equipment 10 for communicating with the second user equipment 11 over the D2D connection. Communication over a D2D connection may generate radio interference towards a neighboring cell. The D2D communication may also experience radio interference from a user equipment or user equipments communicating over a device-to-device connection in a neighboring cell, such as the second cell 15. It should be understood that the first radio base station 12 may serve the second cell 15 if the first radio base station 12 supports multiple cells or sectors, and the second radio base station 13 in the illustrated example comprises an arrangement serving the second cell 15.

By letting the first radio base station 12 and second radio base station 13 inform each other about a radio resource or resources, herein referred to as the first radio resource, allocated for D2D communications within respective cell, and the respective radio base station takes this information into account when scheduling a radio resource herein referred to as the second radio resource, to user equipments within respective cell, the radio interference, such as inter-cell interference, caused by D2D communications may be mitigated.

Hence, according to embodiments herein, the first radio base station 12 determines that the first radio resource e.g. a RB, is allocated to the first user equipment 10 for communicating over a D2D connection with the second user equipment 11 within the first cell 14. The first radio base station then transfers information to an arrangement serving the second cell 15. In the illustrated examples, the arrangement is comprised in the second radio base station 13 and the information is transmitted to the second radio base station 13. Alternatively or additionally, the arrangement may be comprised in the first radio base station 12 if the first radio base station 12 is a radio base station serving a plurality of cells including the first cell 14 and second cell 15. The information identifies the first radio resource and indicates that the first radio resource is allocated to the first user equipment 10 for communicating over the D2D connection with the second user equipment 11. The second radio base station 13 may then use this received information for scheduling the second radio resource to the third user equipment 16 in the second cell 15.

For example, the second radio base station 13 may avoid scheduling a corresponding radio resource that corresponds to the identified radio resource in the received information to the third user equipment 16 when being close to the first cell. The second radio base station 13 may also avoid scheduling the corresponding radio resource for D2D communication between the third user equipment 16 and the fourth user equipment 17. Corresponding radio resource here means that the radio resource identified in time and frequency corresponds to a radio resource identified with the same time and frequency but in a different cell.

The information may be transmitted to the second radio base station 13 in messages e.g. by extending existing standardized X2 inter-radio base station traffic load indicator (TLI) and Overload Indicator (OI) messages. These messages may then be used in different interference algorithms that make use of the information in the messages. Embodiments herein may be used for different types of multi cell networks, e.g. frequency division duplex or time division duplex networks, and different types of inter-cell inter-device interference coordination techniques e.g. in time or frequency domain.

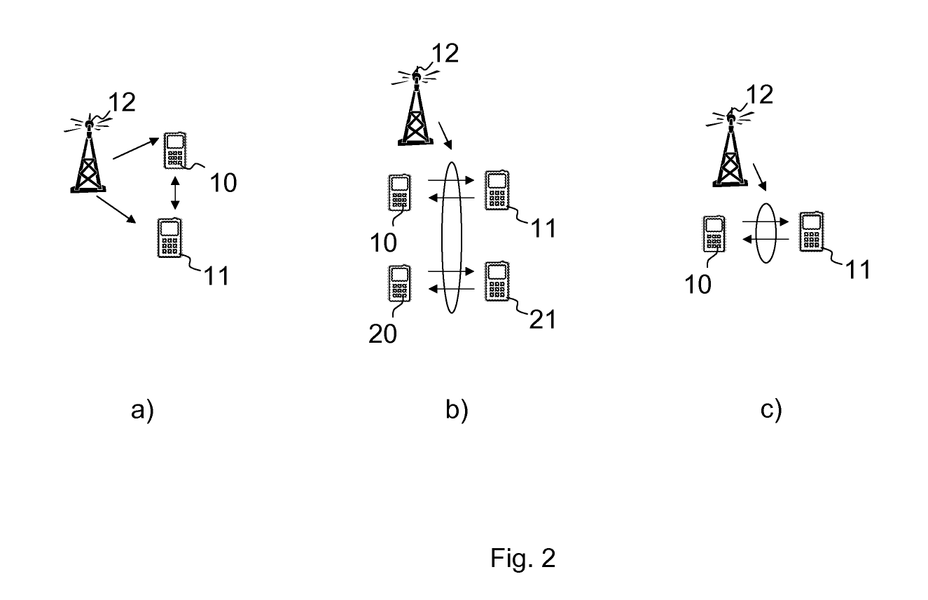

FIGS. 2a-2c are schematic overviews of different examples of resource allocation alternatives in network assisted device to device communications.

As shown in FIG. 2a, the first radio base station 12 may allocate or schedule, referred to herein as allocate, a radio resource on a Transmission Time Interval (TTI) basis for D2D communication between the first user equipment 10 and the second user equipment 11.

FIG. 2b illustrates that the first radio base station 12 may allocate a pool of joint radio resources for bi-directional D2D connections. For example, an amount of radio resources allocated for the D2D connection from which the first user equipment may allocate a radio resource to be used between the first user equipment 10 and the second user equipment 11, and another radio resource of the pool for communication between a fifth user equipment 20 and a sixth user equipment 21.

FIG. 2c illustrates that the first radio base station 12 may allocate a dedicated radio resource for an UL communication and a dedicated radio resource for a DL of the bi-directional D2D connection.

Embodiments herein are applicable in all three cases, wherein the first radio base station 12 determines and may generate a message, which message comprises information identifying and indicating the radio resource or resources, herein after referred to as radio resource, allocated to D2D communications within the first cell 14.

An advantage of the embodiments herein is that a basic building block for a range of radio interference reduction mechanisms is provided that may depend on the intra-cell resource reservation schemes shown in FIGS. 2a-2c, similarly to the existing X2 TLI and OI ICIC message.

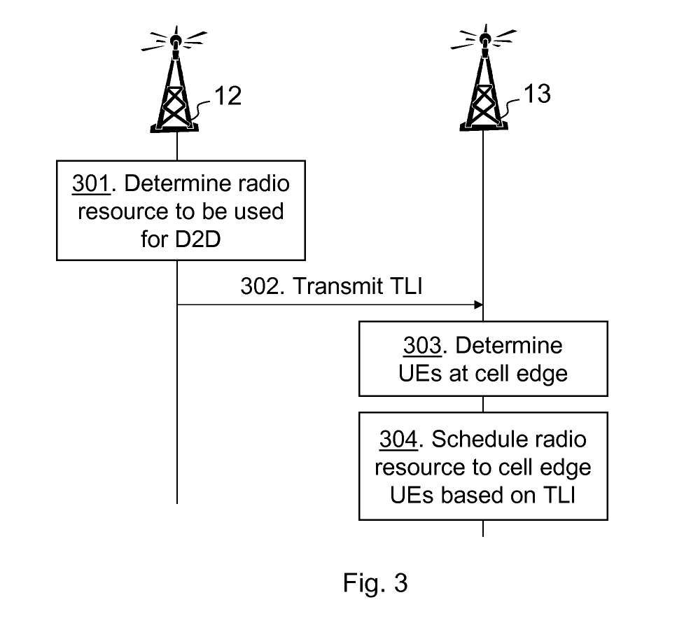

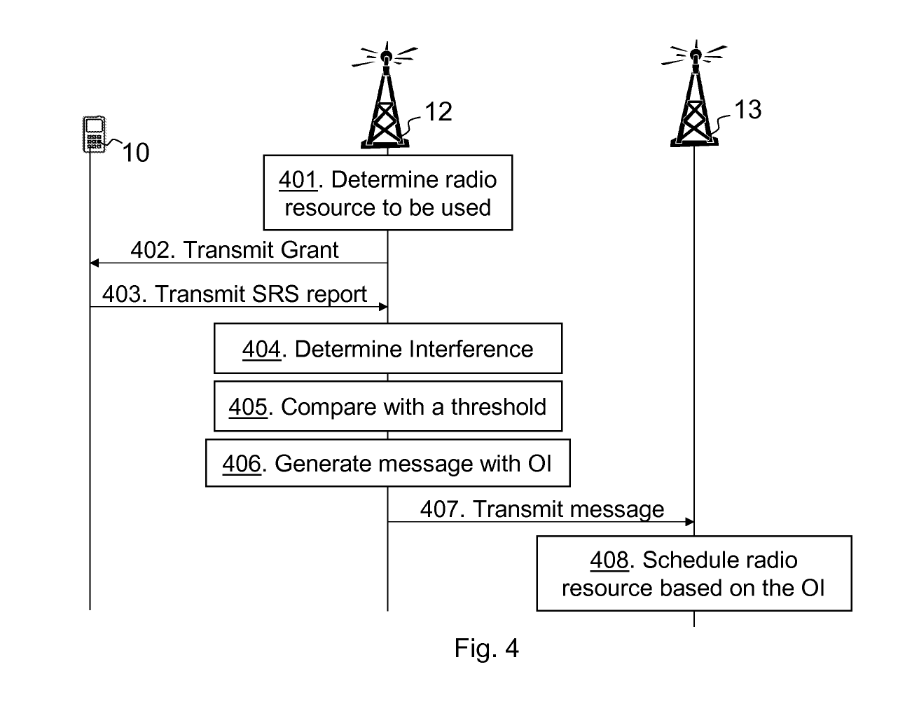

As stated above, the mechanism of informing of possible radio interference may be implemented by e.g. extending a traffic load indicator (TLI) and an overload indicator (OI) in inter base station messages, exemplified as X2 messages in LTE. Thus, the inter base station messages from the first radio base station 12 may carry information about the radio resource that is used for D2D communications within the coverage area of the first cell 14. These extended inter base station messages may be used proactively or reactively as shown in FIG. 3 and FIG. 4.

FIG. 3 is a combined flowchart and signaling scheme in a radio communications network. FIG. 3 relates to embodiments herein, where the first radio base station 12 operates in a proactive mode, and where an indication that a radio resource is used for D2D communication is added to e.g. an TLI in a message. This message may be used to inform neighbor base stations, e.g. the second radio base station 13, about one or a set of resource blocks in the time and/or frequency domain that will be used for D2D communications in the first cell 14. The second cell 15 may then avoid using such resource blocks for user equipments positioned near the cell edge and/or user equipments in D2D communications within the second cell 15. The method comprises the following steps that may be performed in any suitable order.

Step 301. The first radio base station 12 determines that the first radio resource is allocated for D2D communications. The first radio base station 12 may e.g. read the allocation or scheduling scheme of radio resources from a memory circuit in the first radio base station 12. The first radio base station 12 may allocate the first radio resource for a communication over a D2D connection. For example, the first radio base station 12 may allocate the first radio resource to a D2D connection based on other radio resources used in the first cell 14 in order to reduce intra-cell interference. The first radio base station 12 may do this at different time scales and may follow different resource allocation strategies as illustrated in FIGS. 2a-c.

Considering a single cell, two resource allocation strategies may be used when allocating a radio resource for D2D communication. In a first case, D2D connections and cellular connections, which are communicating with the first radio base station 12, may be allocated orthogonal radio resources. In this first case, there is no intra-cell interference between D2D and cellular connections. In a second case, D2D and cellular connections may reuse the same resource blocks within the coverage area of the first cell 14. In this second case, D2D and cellular connections may cause interference to one another within the cell, also known as intra-cell interference.

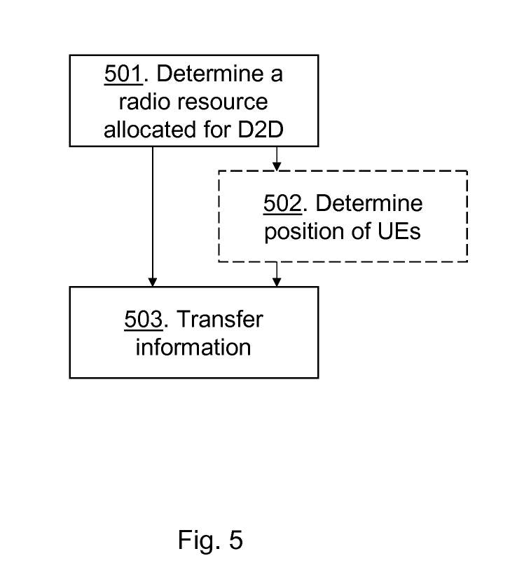

In both cases D2D connections and cellular connections of the cells being close or adjacent one another, e.g. neighboring cells, may interfere with each other. An advantage of the first case above is that intra-cell interference is eliminated, while the second case approach allows for high spectrum efficiency, since OFDM resource blocks may be reused within the first cell 14. Embodiments herein are applicable in both cases. The radio resources to be allocated in the first cell 14 may also be pre-set in the first radio base station 12. This step is an example of step 501 in FIG. 5, described below.

Step 302. The first radio base station 12 may transfer information that identifies the first radio resource and indicates that the first radio resource is allocated for a D2D connection with within the first cell 14. In the illustrated example, the information is transferred by transmitting a Traffic Load Indicator (TLI) extended with D2D information, also referred to as D2D TLI, to one or more arrangements serving other e.g. neighboring cells, such as the second cell 15. In the illustrated example, the information is transmitted to neighbor radio base stations, e.g. the second radio base station 13.

Alternatively or additionally, in cases illustrated in FIG. 2a and FIG. 2c, the first radio base station 12 may use methods to determine positions of the specific D2D pair for which radio resources are allocated and may send the D2D TLI to specific neighbor cells only based on the determined positions. Thus, only neighbor cells that are affected by the D2D communications are informed, resulting in a more efficient signaling which is an advantage.

The first radio base station 12 may generate a message comprising the D2D TLI. The D2D TLI may comprise information about the specific UL or DL resource blocks used for D2D communications in the first cell 14 of the first radio base station 12. For example, this may be a list of OFDM resource blocks in the frequency domain and/or a list of subframes in the subsequent OFDM frames in the time domain during which D2D communications will be scheduled. Furthermore, the D2D TLI may additionally comprise a maximum transmit power that the transmitting (TX) user equipment 10,11 of the D2D connection is allowed to use. In addition, the D2D TLI may comprise geometrical position of the first user equipment 10 and the second user equipment of the D2D pair if such information is available.

These pieces of information may be useful for the neighboring cells, e.g. the second cell 15, when the arrangement serving a neighboring cell, such as the second radio base station 13, decides on mode selection e.g. for a specific D2D candidate and resource allocation for a D2D pair, cases in FIGS. 2a and 2c, or a pool of D2D pairs, illustrated in FIG. 2b. This step is an example of step 503 in FIG. 5, described below.

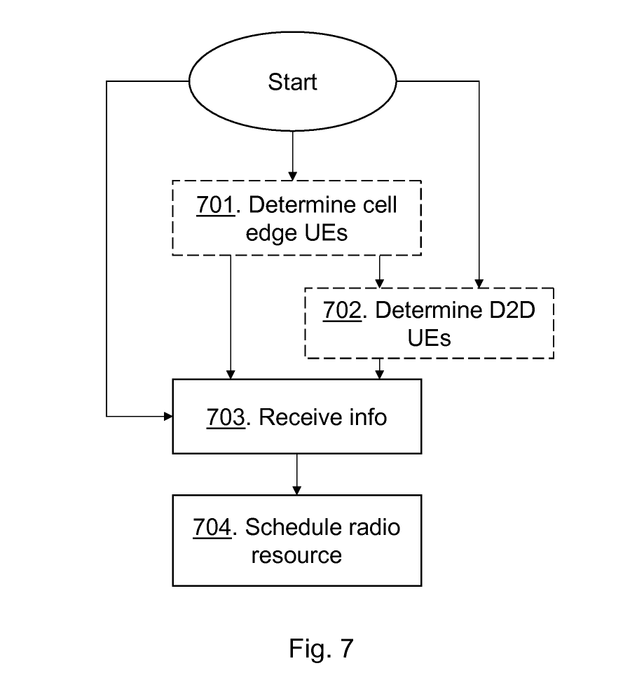

Step 303. The second radio base station 13 may determine a position of the third user equipment 16 in the second cell 15 and additionally the position of the fourth user equipment 17 in the second cell 15. The position may be a received position from respective user equipment 16,17, a measured position at the second radio base station 13 and/or received positions from a positioning node in a core network of the radio communications network. For example, the second radio base station 13 may determine whether any of the user equipments is within a distance range of a border of the second cell 15 or the geometrical location may be determined and compared to a radio coverage area of the first radio base station 12. This step is an example of step 702 in FIG. 7 described below.

Step 304. The second radio base station 13 may then schedule the second radio resource to the third user equipment 16 and/or the fourth user equipment 17 taking the received information into account. Thus, the second radio base station 13 may not schedule a radio resource corresponding to the first radio resource indicated in the received message as a radio resource used for D2D communication, if the third user equipment 16 is close to the border of the second cell 15, close to radio coverage of the first radio base station 12 and/or is to directly communicate with the fourth user equipment 17. Thereby, the radio interference, such as inter-cell interference, is reduced or avoided between the first cell 14 and the second cell 15. Another example may be that the second radio base station 13 limits a transmit power of the third or fourth user equipment 16,17, whichever is a transmitting user equipment, that the third or fourth user equipment 16,17 may use on the resource blocks on which the third or fourth user equipment 16,17 is scheduled. Thereby, the radio interference that the third or fourth user equipment 16,17 causes to the neighbor cell is limited. This step is an example of step 704 in FIG. 7 described below.

As an alternative and/or complement to the message with a TLI, the first radio base station 12 may send a message with an OI to its neighbor cells. This message is basically a request to one or more neighbor cells regarding the resource allocation as opposed to the TLI that informs neighbors about the sender's resource allocation.

FIG. 4 is a combined flowchart and signaling scheme in a radio communications network. FIG. 4 relates to embodiments working in a reactive mode, where information that radio resource is used for D2D communication is added to the OI in a message. This message is used to inform the second radio base station 13 that the received interference is too high on certain resource resources and the first radio base station 12 requests the second radio base station 13 not to use a corresponding radio resource for D2D communications in the second cell 15.

Step 401. The first radio base station 12 determines that the first radio resource is allocated for D2D communications. For example, the first radio base station 12 may allocate the first radio resource for a communication over a D2D connection between the first user equipment 10 and the second user equipment 11. This step corresponds to the step 301 in FIG. 3 above and is an example of step 501 in FIG. 5 described below.

Step 402. The first radio base station 12 may transmit a grant to the first user equipment 10 and the second user equipment 11, which grant indicates the first radio resource to be used for D2D communication.

Step 403. The first user equipment 10 then reports back to the first radio base station interference measurements or indications, e.g. Sounding Reference Signal (SRS) measurements, of the D2D connection between the first user equipment 10 and the second user equipment 11.

Step 404. The first radio base station 12 may determine the level of interference on the first radio resource allocated to the D2D communication by analyzing the received interference measurements.

Step 405. The first radio base station 12 may then compare the determined level of interference with a threshold value of interference. The threshold value may be pre-set by an operator or set based on traffic within the first cell 14.

Step 406. The first radio base station 12 may then generate a message comprising information identifying the first radio resource and indicating that the first radio resource is used for D2D communication in the first cell 14. The information may be added to the OI. The OI is to be sent to the first cell's one or more neighbor cells. In the illustrated example, the OI indicates a request to the second radio base station 13 regarding the resource allocation at the second cell 15.

Step 407. The first radio base station 12 transmits the message to the arrangement serving the second cell 15, which is in the illustrated examples the second radio base station 13. This step is an example of step 503 in FIG. 5 described below.

Step 408. The second radio base station 13 serving the second cell 15 schedules a second radio resource to the third user equipment 16 in the second cell 15. The second radio base station 13 takes the received information into account when scheduling the second radio resource. For example, the third user equipment 16 is communicating with the fourth user equipment 17 over the second radio resource corresponding to the first radio resource identified in the received information. The second radio base station 13 receives the message with the OI and therefore changes the allocation of the second radio resource, reallocates the second radio resource, either to user equipment using a cellular connection via the second radio base station 13 or a D2D connection not close to the first cell 14. Thus, the second radio base station 13 may change an allocation mode, from D2D mode to cellular mode, reallocate radio resource or similar. Additionally, when the second radio resource is not corresponding to the first radio resource identified in the received information, the second radio resource may be allocated for D2D communication for user equipments positioned close to the first cell 14 or within a distance range of the border of the first cell 14. Additionally or alternatively, the second radio base station 13 receiving the message with the OI from the first radio base station 12 may instruct the third user equipment 16, if e.g. the third user equipment 16 is a transmitter of a D2D pair, to reduce the transmit power on the resource blocks on which transmission from the third user equipment 16 is scheduled. This step is an example of step 704 in FIG. 7 described below.

In a sense the proactive and reactive modes are similar to the current use of the X2 indicators. In the proactive mode the first radio base station 12, being the transmitter, informs the second radio base station 13, being the receiver, about a future action; while in reactive mode, the transmitter requests an action by the receiver based on a past event.

The method steps in the radio base station, referred to as the first radio base station 15 in the figures, for handling radio interference in a radio communications network according to some general embodiments will now be described with reference to a flowchart depicted in FIG. 5. As mentioned above, the first radio base station 12 provides radio coverage over a geographical area forming a first cell 14. In the first cell 14 a first user equipment 10 and a second user equipment 11 are served. The first radio base station 12, the first user equipment 10 and the second user equipment 11 are comprised in the radio communications network. The method steps do not have to be taken in the order stated below, but may be taken in any suitable order.

Step 501. The first radio base station 12 determines that a first radio resource is allocated to the first user equipment 10 for communicating over a D2D connection with the second user equipment 11 within the first cell 14.

Step 502. The first radio base station 12 may determine a position of at least one user equipment out of the first user equipment 10 and the second user equipment 11. For example, GPS coordinates may be received from the user equipments 10,11 or the first radio base station 12 may perform a triangulation or similar. Step 502 is performed in some embodiments as indicated by the dashed line.

Step 503. The first radio base station 12 transfers information to an arrangement serving a second cell 15. The information identifies the first radio resource and indicates that the first radio resource is allocated to the first user equipment 10 for communicating over the D2D connection with the second user equipment 11 within the first cell 14. The information is to be taken into account by the arrangement serving the second cell 15 for scheduling a second radio resource to a third user equipment 16 in the second cell 15. The arrangement may be comprised in a second radio base station 13 serving the second cell 15 or may comprise circuits in the first radio base station 12 that serve the second cell 15 in case the first radio base station 12 serves a plurality of cells. When the arrangement is comprised in the second radio base station 13 the information is transferred in that the first radio base station transmits a traffic load indicator comprising the information in a message to the second radio base station 13. In some embodiments, the first radio base station 12 is triggered to transfer the information when a radio interference on the first radio resource is above a threshold value. The information may be transferred by transmitting the information in an overload indicator in a message to the second radio base station 13. The overload indicator indicates that a corresponding radio resource in the second cell 15 is not to be scheduled to the third user equipment 16. A corresponding radio resource corresponds to the first radio resource identified in the information. The information may comprise frequency and time identifying the first radio resource, but also maximum transmission power, position of the first user equipment 10 and/or the position of the second user equipment 11.

In some embodiments, wherein the first radio base station 12 has determined position of at least one user equipment out of the first user equipment 10 and the second user equipment 11, the first radio base station 12 may transfer the information when the at least one user equipment is within a distance range of a border of the first cell 14 and/or a border of the second cell 15. For example, the first radio base station 12 may know the geographical area which the second cell 15 covers, and may determine that if the first user equipment 10 is within a distance of 100 meters of the first cell border in the direction of the coverage area of the second cell 15, the information is to be transmitted to the second radio base station 13.

The information may comprise; information identifying the first radio resource as a set of resource blocks in a frequency domain and time domain; a maximum transmit power used in the D2D connection; a reuse indication; a position of the first user equipment 10 and/or a position of the second user equipment 11. The information may in some embodiments comprise one or more bits indicating whether the first radio resource is used or not used for D2D communications.

The information may be reported on a Transmission Time Interval (TTI) basis. For example, a resource block may be identified in frequency and time and indicated if used as D2D resource. The resource block may be indicated with one or more bits is reused in the first cell 14, e.g. ‘10’ means that the resource block is used for cellular communication, ‘01’ means that the resource block is used for D2D communication, ‘11’ means that the resource block is used for both cellular communication and D2D communication, and ‘00’ means that the resource block is not used.

Thus, the messages comprising TLI and/or OI may also describe whether a particular Resource Block (RB), such as a OFDM resource block, is used for cellular communication, D2D communication, both or none during a specific time interval. As stated above, the TLI and OI may comprise 2 bits for each RB specifying the particular usage of each RB.

Both the TLI and OI messages may be triggered by changes in the mode selection by the first radio base station 12. For example, when the first radio base station 12 changes from a first mode allocating radio resources for D2D communication from a pool of radio resource, to a second mode allocating radio resource on a TTI basis, the first radio base station 12 initiates reporting of the radio resources used for D2D or similar.

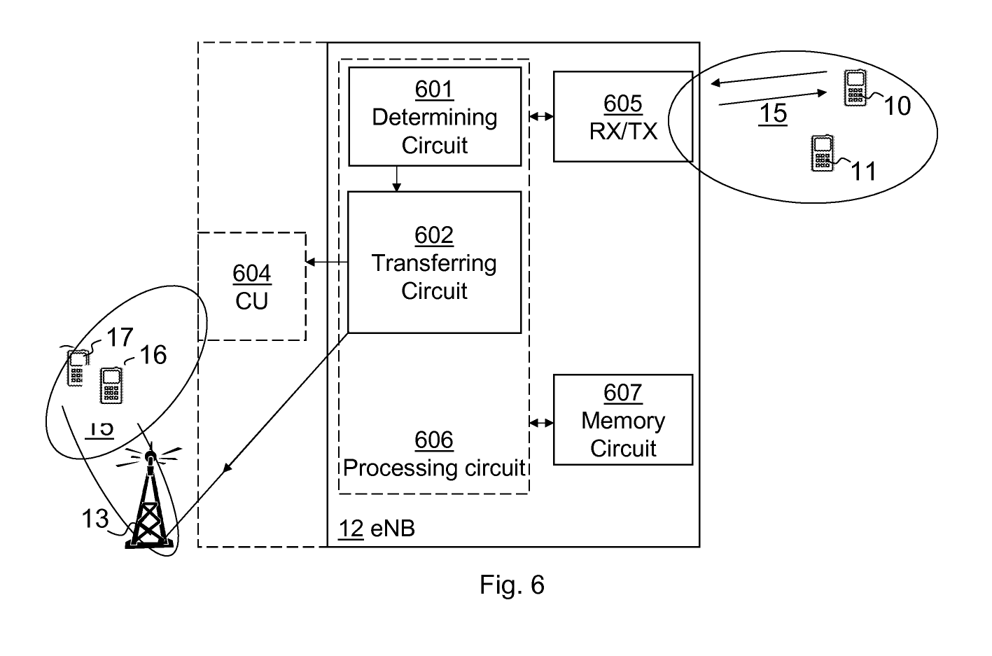

In order to perform the method steps of handling radio interference in the radio communications network the radio base station 12 is provided. FIG. 6 is a block diagram of a radio base station, referred to as the first radio base station in the figures. As mentioned above, the first radio base station 12 is configured to provide radio coverage over a geographical area forming a first cell 14 configured to serve a first user equipment 10 and a second user equipment 11.

The first radio base station 12 comprises a determining circuit 601 configured to determine that a first radio resource is allocated to the first user equipment 10 for communicating over a device-to-device, D2D, connection with the second user equipment 11 within the first cell 14. The determining circuit 601 may further be configured to determine a position of at least one user equipment out of the first user equipment 10 and the second user equipment 11.

The first radio base station further comprises a transferring circuit 602 configured to transfer information to an arrangement serving a second cell 15. The information identifies the first radio resource and indicates that the first radio resource is allocated to the first user equipment 10 for communicating over the D2D connection with the second user equipment 11 within the first cell 14. The information is to be taken into account by the arrangement serving the second cell 15 for scheduling a second radio resource to a third user equipment 16 in the second cell 15.

In some embodiments, the arrangement may be comprised in a second radio base station 13, and the transferring circuit 602 is configured to transmit a traffic load indicator comprising the information in a message to the second radio base station 13.

In some embodiments, the transferring circuit 602 is configured to be triggered to transfer the information when a radio interference on the first radio resource is above a threshold value. The transferring circuit 602 may be configured to transmit the information in an overload indicator in a message to the second radio base station 13. The overload indicator indicates that a corresponding radio resource in the second cell 15 is not to be scheduled to the third user equipment 16, which corresponding radio resource corresponds to the first radio resource identified in the information.

The transferring circuit 602 may further be configured to transfer the information when the at least one user equipment is within a distance range of a border of the first cell 14 and/or a border of the second cell 15.

The information may comprise: information identifying the first radio resource as a set of resource blocks in a frequency domain and time domain; a maximum transmit power used in the D2D connection; a reuse indication; a position of the first user equipment 10 and/or a position of the second user equipment 11. The information may alternatively or additionally comprise one or more bits indicating whether the first radio resource is used or not used for D2D communications.

The information may be transferred to a control unit (CU) 603 in the first radio base station 12 in case the first radio base station 12 also controls the second cell 15.

The position of the user equipments may be based on information received via a receiving/transmitting circuit (RX/TX) 604 from the user equipments 10,11, which may also receive reports on radio interference of the radio resources used by the D2D pair. Also, an allocation grant may be sent over the RX/TX 604 to the different user equipments 10,11.

The embodiments herein for handling radio interference in the radio communications network may be implemented through one or more processors, such as a processing circuit 605 in the first radio base station 12 depicted in FIG. 6, together with computer program code for performing the functions and/or method steps of the embodiments herein. The program code mentioned above may also be provided as a computer program product, for instance in the form of a data carrier carrying computer program code for performing the present solution when being loaded into the first radio base station 12. One such carrier may be in the form of a CD ROM disc. It is however feasible with other data carriers such as a memory stick. The computer program code may furthermore be provided as pure program code on a server and downloaded to the first radio base station 12.

The first radio base station 12 may comprise a memory 606. The memory 606 may comprise one or more memory units and may be used to store e.g. data such as threshold values of distance ranges or interference values, quality values, allocation schemes, radio resource information, positions, cell border information, neighbouring cells data, applications to perform the methods herein when being executed on the first radio base station 12 or similar.

The method steps in the radio base station, referred to as the second radio base station 13 in the figures, for scheduling a second radio resource to be used by a third user equipment in the radio communications network according to some general embodiments will now be described with reference to a flowchart depicted in FIG. 7. The steps do not have to be taken in the order stated below, but may be taken in any suitable order.

The second radio base station 13 provides radio coverage over a geographical area forming a second cell 15, in which second cell 15 the third user equipment 16 is served. The second radio base station 13 and the third user equipment 16 are comprised in the radio communications network.

Step 701. The second radio base station 13 may determine that the third user equipment 16 is within a distance range of a cell border of the second cell 15 or the first cell 14. Step 701 is performed in some embodiments as indicated by the dashed line.

Step 702. The second radio base station 13 may determine that the third user equipment 16 is communicating over a D2D connection with a fourth user equipment 17 in the second cell 15. Step 702 is performed in some embodiments as indicated by the dashed line.

Step 703. The second radio base station receives information from an arrangement serving a first cell 14, which information identifies a first radio resource and indicates that the first radio resource is allocated to a first user equipment 10 for communicating over a device-to-device, D2D, connection with a second user equipment 11 within the first cell 14.

Step 704. The second radio base station 13 schedules a second radio resource to the third user equipment 16 by taking the information into account.

In some embodiments, when the third user equipment 16 is within a distance range of a cell border of the second cell 15 or the first cell 14, the second radio base station 13 schedules the second radio resource by allocating the second radio resource in the second cell (15), that is not corresponding to the first radio resource identified in the received information.

In some embodiments, when the third user equipment 16 is communicating over a D2D connection with the fourth user equipment 17 in the second cell 15, the second radio base station 13 schedule the second radio resource by allocating the second radio resource in the second cell 15 for D2D communication, wherein the second radio resource is not corresponding to the first radio resource identified in the received information.

The information may be comprised in a traffic load indicator in a message from the arrangement, wherein the arrangement is comprised in a first radio base station 12.

The information may alternatively or additionally be comprised in an over load indicator in a message from the arrangement, wherein the arrangement is comprised in a first radio base station 12. The overload indicator may indicate that a radio interference on the first radio resource is above a threshold value.

The received information may alternatively or additionally comprise: information identifying the first radio resource as a set of resource blocks in a frequency domain and time domain; a maximum transmit power used in the D2D connection; a reuse indication; a position of the first user equipment 10 and/or a position of the second user equipment 11.

The scheduling 704 may comprise to reallocate the second radio resource from the third user equipment 16 when the third user equipment 16 communicates over a D2D connection with the fourth user equipment 17 in the second cell 15 to a user equipment close to the second radio base station 13 in a cellular mode. The second radio resource corresponds to the first radio resource identified in the message.

In some embodiments an upper power limit for the RBs that are used for D2D communications may be set.

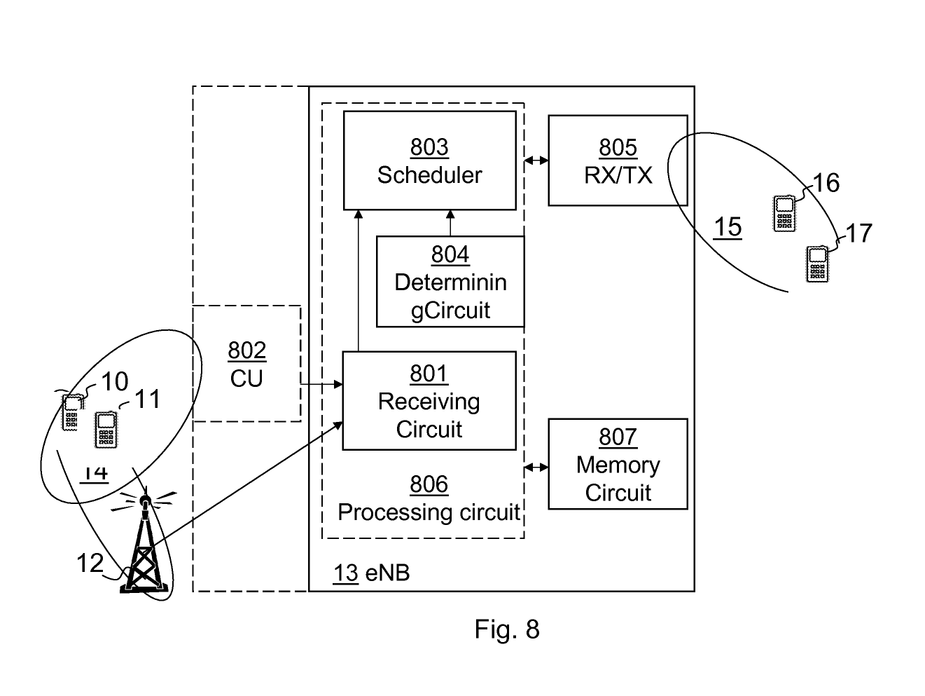

FIG. 8 is a block diagram depicting the second radio base station 13 for scheduling a second radio resource to be used by the third user equipment 16 in the radio communications network. The second radio base station 13 is configured to provide radio coverage over a geographical area forming a second cell 15, and configured to serve the third user equipment 16.

The second radio base station 13 comprises a receiving circuit 801 configured to receive information from an arrangement serving a first cell 14. The information identifies a first radio resource and indicates that the first radio resource is allocated to a first user equipment 10 for communicating over a device-to-device, D2D, connection with a second user equipment (11) within the first cell 14. The arrangement may be comprised in a first radio base station 12 or component/circuits, e.g. a Control Unit (CU) 802 in the second radio base station 13 in the case the second radio base station 13 controls the first and the second cell.

The second radio base station 13 further comprises a scheduler 803 configured to schedule the second radio resource to the third user equipment 16 taking the information into account.

In some embodiments, the second radio base station 13 may comprise a determining circuit 804 configured to determine that the third user equipment 16 is within a distance range of a cell border of the second cell 15 or the first cell 14. This may be determined on reports or similar from the third user equipment 16 via a receiving/transmitting circuit (RX/TX) 805. When that is the case, the scheduler 803 may be configured to allocate the second radio resource in the second cell wherein the second radio resource is not corresponding to the first radio resource identified in the received information.

The determining circuit 804 may alternatively or additionally be configured to determine that the third user equipment 16 is communicating over a D2D connection with a fourth user equipment 17 in the second cell 15. When that is the case, the scheduler 803 may further be configured to allocate the second radio resource in the second cell 15. The second radio resource is not corresponding to the first radio resource identified in the received information. Information regarding allocated second radio resource may be transmitted to the third user equipment 16 over the RX/TX 805.

The information is comprised in a traffic load indicator in a message from the arrangement, wherein the arrangement is comprised in a first radio base station 12. The information may alternatively or additionally be comprised in an over load indicator in a message from the arrangement, wherein the arrangement is comprised in a first radio base station 12. The overload indicator may indicate that a radio interference on the first radio resource is above a threshold value.

The received information may comprise: information identifying the first radio resource as a set of resource blocks in a frequency domain and time domain; a maximum transmit power used in the D2D connection; a reuse indication; a position of the first user equipment 10 and/or a position of the second user equipment 11.

The embodiments herein for scheduling the second radio resource to be used by the third user equipment 16 in the radio communications network may be implemented through one or more processors, such as a processing circuit 806 in the second radio base station 13 depicted in FIG. 8, together with computer program code for performing the functions and/or method steps of the embodiments herein. The program code mentioned above may also be provided as a computer program product, for instance in the form of a data carrier carrying computer program code for performing some embodiments when being loaded into the second radio base station 13. One such carrier may be in the form of a CD ROM disc. It is however feasible with other data carriers such as a memory stick. The computer program code may furthermore be provided as pure program code on a server and downloaded to the second radio base station 13.

The second radio base station 13 may further comprise a memory 807. The memory 807 may comprise one or more memory units and may be used to store e.g. data such as threshold values, quality values, allocation scheme, radio resource information, positions, cell border information, neighbouring cells data, applications to perform the methods herein when being executed on the second radio base station 13 or similar.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the invention being defined by the following claims.

1. A method in a first radio base station for handling radio interference in a radio communications network, the first radio base station provides radio coverage over a geographical area forming a first cell that serves a first user equipment and a second user equipment, which first radio base station, the first user equipment and the second user equipment are comprised in the radio communications network, the method comprising:
determining that a first radio resource is allocated to the first user equipment for communicating over a device-to-device, D2D, connection with the second user equipment within the first cell, and
transferring information to an arrangement serving a second cell, which information identifies the first radio resource and indicates that the first radio resource is allocated to the first user equipment for communicating over the D2D connection with the second user equipment within the first cell, and which information is taken into account by the arrangement serving the second cell for scheduling a second radio resource to a third user equipment in the second cell.

2. The method according to claim 1, wherein the arrangement is comprised in a second radio base station, and wherein the information is transferred by transmitting a traffic load indicator comprising the information in a message to the second radio base station.

3. The method according to claim 1, wherein:
the arrangement is comprised in a second radio base station, and wherein the transferring is triggered based on a radio interference on the first radio resource being above a threshold value, and
the information is transferred by transmitting the information in an overload indicator in a message to the second radio base station, which overload indicator indicates that a corresponding radio resource in the second cell is not to be scheduled to the third user equipment, which corresponding radio resource corresponds to the first radio resource identified in the information.

4. The method according to claim 1, further comprising:
determining a position of at least one user equipment out of the first user equipment and the second user equipment, and the transferring is performed based on the at least one user equipment being within a distance range of a border of the first cell and/or a border of the second cell.

5. The method according to claim 1, wherein the information comprises:
information identifying the first radio resource as a set of resource blocks in a frequency domain and time domain; a maximum transmit power used in the D2D connection; a reuse indication; a position of the first user equipment; and/or a position of the second user equipment.

6. The method according to claim 1, wherein the information comprises one or more bits indicating whether the radio resource is used or not used for D2D communications.

7. A method in a second radio base station for scheduling a second radio resource to be used by a third user equipment in a radio communications network, the second radio base station provides radio coverage over a geographical area forming a second cell that serves the third user equipment, and wherein the second radio base station and the third user equipment are comprised in the radio communications network, the method comprising:
receiving information from an arrangement serving a first cell, which information identifies a first radio resource and indicates that the first radio resource is allocated to a first user equipment for communicating over a device-to-device, D2D, connection with a second user equipment within the first cell, and
scheduling a second radio resource to the third user equipment by taking the information into account.

8. The method according to claim 7, further comprising:
determining that the third user equipment is within a distance range of a cell border of the second cell or the first cell, and when that is the case, the scheduling is performed by allocating the second radio resource in the second cell, that is not corresponding to the first radio resource identified in the received information.

9. The method according to claim 7, further comprising:
determining that the third user equipment is communicating over a D2D connection with a fourth user equipment in the second cell, and when that is the case, the scheduling is performed by allocating the second radio resource in the second cell, that is not corresponding to the first radio resource identified in the received information.

10. The method according to claim 7, wherein the information is comprised in a traffic load indicator in a message from the arrangement, wherein the arrangement is comprised in a first radio base station.

11. The method according to claim 7, wherein the information is comprised in an over load indicator in a message from the arrangement, wherein the arrangement is comprised in a first radio base station, which overload indicator indicates that a radio interference on the first radio resource is above a threshold value.

12. The method according to claim 7, wherein the received information comprises:
information identifying the first radio resource as a set of resource blocks in a frequency domain and time domain; a maximum transmit power used in the D2D connection; a reuse indication; a position of the first user equipment, and/or a position of the second user equipment.

13. A first radio base station for handling radio interference in a radio communications network, which first radio base station is configured to provide radio coverage over a geographical area forming a first cell configured to serve a first user equipment and a second user equipment, the first radio base station comprises:
a determining circuit configured to determine that a first radio resource is allocated to the first user equipment for communicating over a device-to-device, D2D, connection with the second user equipment within the first cell, and
a transferring circuit configured to transfer information to an arrangement serving a second cell, which information identifies the first radio resource and indicates that the first radio resource is allocated to the first user equipment for communicating over the D2D connection with the second user equipment within the first cell, and which information is to be taken into account by the arrangement serving the second cell for scheduling a second radio resource to a third user equipment in the second cell.

14. The first radio base station according to claim 13, wherein the arrangement is comprised in a second radio base station, and wherein the transferring circuit is configured to transmit a traffic load indicator comprising the information in a message to the second radio base station.

15. The first radio base station according to claim 13, wherein:
the arrangement is comprised in a second radio base station, and wherein the transferring circuit is configured to be triggered to transfer the information based on a radio interference on the first radio resource being above a threshold value, and
the transferring circuit is configured to transmit the information in an overload indicator in a message to the second radio base station, which overload indicator indicates that a corresponding radio resource in the second cell is not to be scheduled to the third user equipment, which corresponding radio resource corresponds to the first radio resource identified in the information.

16. The first radio base station according to claim 13, wherein the determining circuit is further configured to determine a position of at least one user equipment out of the first user equipment and the second user equipment, and the transferring circuit is configured to transfer the information based on the at least one user equipment being within a distance range of a border of the first cell and/or a border of the second cell.

17. The first radio base station according to claim 13, wherein the information comprises:
information identifying the first radio resource as a set of resource blocks in a frequency domain and time domain; a maximum transmit power used in the D2D connection; a reuse indication; a position of the first user equipment, and/or a position of the second user equipment.

18. The first radio base station according to claim 13, wherein the information comprises one or more bits indicating whether the radio resource is used or not used for D2D communications.

19. A second radio base station, for scheduling a second radio resource to be used by a third user equipment in a radio communications network, which second radio base station is configured to provide radio coverage over a geographical area forming a second cell configured to serve the third user equipment, the second radio base station comprising:
a receiving circuit configured to receive information from an arrangement serving a first cell, which information identifies a first radio resource and indicates that the first radio resource is allocated to a first user equipment for communicating over a device-to-device, D2D, connection with a second user equipment within the first cell, and
a scheduler configured to schedule a second radio resource to the third user equipment taking the information into account.

20. The second radio base station according to claim 19, further comprising:
a determining circuit configured to determine that the third user equipment is within a distance range of a cell border of the second cell or the first cell, and when that is the case, the scheduler is further configured to allocate the second radio resource in the second cell, that is not corresponding to the first radio resource identified in the received information.

21. The second radio base station according to claim 19, further comprising:
a determining circuit configured to determine that the third user equipment is communicating over a D2D connection with a fourth user equipment in the second cell, and when that is the case, the scheduler is further configured to allocate the second radio resource in the second cell, that is not corresponding to the first radio resource identified in the received information.

22. The second radio base station according to claim 19, wherein the information is comprised in a traffic load indicator in a message from the arrangement, wherein the arrangement is comprised in a first radio base station.

23. The second radio base station according to claim 19, wherein the information is comprised in an over load indicator in a message from the arrangement, wherein the arrangement is comprised in a first radio base station, which overload indicator indicates that a radio interference on the first radio resource is above a threshold value.

24. The second radio base station according to claim 19, wherein the received information comprises:
information identifying the first radio resource as a set of resource blocks in a frequency domain and time domain; a maximum transmit power used in the D2D connection; a reuse indication; a position of the first user equipment, and/or a position of the second user equipment.
